(19) United States
(12) Patent Application Publication
(10) Pub. No.: US 2003/0037100 A1
(43) Pub. Date: Feb. 20, 2003

(54) Streamlined data distribution system for commercial applications

(75) Inventors: Robert Olejar, New York, NY (US); Igor Royzis, Brooklyn, NY (US)

Correspondence Address: ISRAEL NISSENBAUM, 1038-56TH ST, BROOKLYN, NY, 11219, US

(73) Assignee: Modelwire, Inc.

(21) Appl. No.: 09/906,651

(22) Filed: Jul. 17, 2001

Related U.S. Application Data
(60) Provisional application No. 60/218,742, filed on Jul. 17, 2000.

(51) Int. Cl. G06F 15/16; G06F 15/173

(52) U.S. Cl. 709/203; 709/223

(57) ABSTRACT

An expedited system for effective on-line linking of a source of text and graphical images such as a modeling agency with a client in need of services, obtained by evaluation of the graphical images. A central server intermediary is connected by an internet connection to a modeling agency data source and the client user. The system offers a communication choice of push, pull or combination of push and pull to enhance and facilitate communication of graphics intensive subject matter. Data replication and updating is done on a real time basis.

### FIELD OF THE INVENTION

This invention relates to a system for the distribution of data of a graphic intensive nature as well as multi-media and particularly with application to personnel appearance evaluation such as in the modeling industry.

### BACKGROUND OF THE INVENTION

Push Distribution Model

Before the Internet, the most typical form of data distribution was by catalog or manual. This business model utilized a “push” technology, which distributed the data to the user before the user needed the data. Catalogs and CD's represent modern forms of this type of pushed data. Push data remains viable in the Internet age by accommodating users who have slow or unreliable Internet access. The data can be pushed to the user in advance so that interaction with the data can occur much faster than through a slow Internet connection.

Even the promise of broadband access has not eliminated the need for push technology. Although bandwidth is constantly growing, the amount of data traffic appears to be growing at a faster pace since users are taking advantage of more sophisticated application programs and related data files. As a result, in many businesses, the available bandwidth is actually getting slower, even with actual bandwidth expanding.

Pull Distribution Model

The concept behind pull technology begins with a user requesting data on an as-needed basis from a source. The source responds to the request by sending information. The most commonly used type of pull technology today is a typical web site. A user types the Internet address (URL) of a site and the server then replies to the request by sending the home page, through the Internet, to the user.

Web browsers have adopted pull technology to incorporate a cache of previously viewed data to minimize the need to re-download some data. This system works when users only browse a very limited volume of data and is generally useful for home users. The main drawback of pure pull technology is the variable performance caused by increased server activity, net congestion or low levels of available bandwidth at user locations.

It is difficult to provide the most efficient ways of delivering data and other resources to multiple users within dynamic industries. Achieving enhanced performance on the Internet by bringing data closer to end users (“caching”) therefore requires a shorter trip by the end user to access that data. This approach however requires the use of multiple servers (hundreds or even thousands) all over the web and the technology consists of a simple movement of data from a central server out to these mirror servers.

While this is an adequate solution for the one-way pull transmission nature of the business-to-consumer segment, vertical industries and the business to business segment are not well served. Under the caching approach, data still resides on the Web and the weakest link problem is not resolved. It is desirable to bring business critical data and images right into the corporate networks of a given industry, thereby eliminating a need to pass data requests through the traffic-congested Internet. This model achieves data access speeds hundreds and even thousands times faster than the existing, web based data delivery and distribution approaches.

A non-limiting example of a business which requires significant data and data access and particularly data of a highly intensive graphics nature is the fashion modeling industry, which is used as an example herein for clarity and simplicity. Other business include fashion and apparel industries, and talent and entertainment casting industries,

The fashion modeling industry is a multi-billion dollar international business involving about 500,000 models worldwide (approximately 200,000 in the U.S.), with $2-4 billion spent annually on fees for modeling services alone. All professional models are affiliated with a modeling agency.

The business of fashion modeling remains burdened by traditional methods of distributing hard copies of models' photographs for consideration by casting agents at ad agencies, magazines and retailers. This process is time-consuming (a typical casting takes two or more weeks), inefficient and very costly to the industry, with current expenditures amounting to $1.5 billion each year in portfolio production and distribution expenses.

The modeling business is composed of three member groups: models, modeling agencies and clients. Each group has a dramatically different number of members, amount of decision-making power, technology needs, and financial concerns.

A model is defined herein as a person who is represented by a modeling agency. Often a modeling agency specializes in one geographic location, usually no larger than a city. Therefore, if a model wishes to be represented in New York, Miami and Paris, he or she would need three different modeling agents.

Modeling agencies are businesses that specialize in representing models to a wide variety of clients, often in the same city. There are more than 1,500 modeling agencies in the United States, which represents half of the worldwide market. A modeling agency maintains a roster of models, which can be divided into different categories (sometimes called boards or divisions) for different types of work. The most common boards are Men and Women. Modeling agencies assist the clients in selecting models and then negotiate fees for the model.

A client of a modeling agency can be defined as any person or business that requires the use of a professional model. Clients can be fashion photographers, magazine editors, department stores, catalogs, fashion designers or advertising agencies.

The existing communication business framework for the fashion industry relies heavily on shipments of model books (portfolios) and composite cards (single pictures on 5″ by 7″ paper). All negotiations are done via telephone.

The model book is the central item in the modeling business. It is a collection of photographs of a single model. The book is a resume of her (for convenience, models will be referred to as being female, though all types of models are represented therewith) previous work and, based upon the quality of that work, can help to dictate higher fees for her future work. It is her only form of promotion to potential clients.

Models begin by taking all of their previous photographs to their modeling agency. The number of photographs varies from model to model. Some models may have only two or three photographs, while other models may have thousands. The modeling agency will take this archive of photographs and choose 20 pictures to include in a model's book. These photographs may be copied to make three or more additional books to assist the agency.

The equivalent of a business card for a model is a composite card (comp card). These cards are normally 5″ by 7″ and have a large picture on the front and several small pictures on the back. The cards are printed in bulk and several are placed inside of the model's book so the client can take them if necessary. They can be relatively expensive, $1.50-$5.00 each.

Once a new model has joined an agency, she is added to a division within the agency. If a model is added to multiple divisions, the model will usually have a different agent (booker) for each division and a different model book. Each booker is responsible for soliciting new clients, submitting books and models for job requests and negotiating fees for each job when models are hired.

A typical job begins with a telephone call from a client to a modeling agency. The client describes what type of model that she is looking for and requests comp cards from the agency. The modeling agency forwards the comp cards to the client for the client's review. The client then selects models from the comp cards, informs the agency's booker, who in turn ships the client the respective books. Usually the client calls multiple agencies, so this process is duplicated at each modeling agency.

Within a day or two, the books arrive from the various modeling agencies. A typical request could involve three or four modeling agencies and result in a total of 80 books. These books are normally gathered together for a quick review. Each book is opened and browsed very quickly. An experienced client will turn the pages of a book as fast as humanly possible on the first review. The first pass through each book is usually for elimination of models, not selection. This could reduce the 80 books to 10 in less than thirty minutes. The final books are then reviewed and normally three or four finalists are chosen. At this point, the remaining 76 books are shipped back to the modeling agencies, and the final 4 books are shipped to another client, usually the final decision maker for this job.

The ultimate client, will receive the final 3-4 books within a day or two for selection. Once the final model is selected, the negotiations begin between the client and the modeling agency. These negotiations are always done via telephone and once completed, the job can begin.

A model has virtually no say in where the portfolio book is shipped, how often it is shipped, or what method of shipment is used. Yet the single biggest annual expense for a model is shipping. A model pays for shipping to each client, from any client to any other client, and even pays for the return of the book from a client back to the modeling agency. A model spends between $4,000 and $30,000 each year in shipping costs alone.

In order to get work, models need to increase the number of times their books get shipped to clients. In order to make money, the models need to reduce the costs of shipping. Under the current system, these two factors work against each other.

Clients have no out-of-pocket costs associated with selecting models for a job. They only pay when they hire a model. At that time, they have to decide on how many days of photography will be needed to take the photographs and where the images will be used. Because there is no set pricing structure for models, each negotiation for fees is different.

A client's main cost is time. The typical model selection process took 8 weeks in 1960 and currently takes 5 days or less. Sometimes, castings have to be completed in hours or minutes and the current system is simply not fast enough.

Virtually all modeling agencies are using computers for accounting, tracking clients, and maintaining a database of models. The client side of the industry is even more technologically savvy.

Modeling agencies are virtually 100% Microsoft Windows-based companies using Pentium class machines, usually on networks with 10 to 15 stations. The largest networks involve 50 or more stations and multiple dedicated servers. Most agencies are connected to the Internet with dedicated access, either with DSL or ISDN. There are occasional dial-up connections and a growing number of T1 lines in use.

The clients of modeling agencies represent a diverse group of users with varying levels of computer knowledge. Clients use computers to review advertising layouts and photograph samples, preview photo shoot locations and communicate with other clients. Advertising agencies, department stores and magazines typically have newer computers and large monitors. Each of these clients may have several people who are involved in the casting process. They almost always have multiple T1 lines. Although these companies have been adding bandwidth on a regular basis, the traffic has been reportedly growing at rates much faster than bandwidth has become available. The congestion of traffic at an advertising agency varies widely. Most often, the available connection is extremely slow, reportedly bordering on unusable.

Many other clients, such as photographers and independent casting agents, have less bandwidth, but little or no traffic. This results in a connection that may ironically be 10 to 100 times faster than most advertising agencies.

Presently there is a trend towards use of multi-media presentations such as video and audio which, because of their heavy transmission requirements further exacerbates the requisite real time transmission rates.

### SUMMARY OF THE INVENTION

It is an object of the present invention to provide a system which comprises an architecture which allows a system to offer the correct technology fit (“push”, “pull” or a combination thereof) for each data user, even if that user's correct fit changes frequently.

It is a further object of the present invention to provide a system which permits a user to request all, or a portion of, the data from the central hub, which data can be downloaded and updated as often as necessary to a local database, whereby the user can work completely offline at maximum speed with the local data and wherein an offline system can even be installed on a notebook computer and used on location where Internet access is not possible.

It is another object of the present invention to provide a system wherein users can also access a central database directly through the Internet to provide live interactivity with different users on the network. The pure pull ensures that the data being viewed is the most up-to-date in order to maximize efficiency. The system permits users to work from any computer that has fast access to the Internet without the need to wait for a download.

It is still yet another object of the present invention to provide a system wherein most users require a combination of push and pull technologies, to enable users to interact with “electronic packages” consisting of references to a subset of multi-media (video, audio, etc.), data (images, files, etc.) that is pre-selected by one user on the network and transmitted to another and wherein the electronic package refers to the multi media or data that already has been pushed forward to all possible end users so that they can manipulate it or transfer it to anyone else on the network almost instantaneously, even on a slow connection. Both multi-media and data will be referred to hereinafter as “data” for convenience.

It is another object of the present invention to provide a system wherein the use of electronic packages allows users to interact with the central database and perform any type of transaction thousands of times faster than an equivalent transaction under a typical push or pull scenario, wherein the electronic packages are ‘intelligent’ and can detect if the local data is complete or inaccurate and automatically retrieves the necessary data from the central hub to complete the transaction.

Another object of the present invention is to provide a system wherein electronic packages can also be used to organize data into personal files for each user, wherein the user can effectively structure a virtual filing system of data sorted in much the same way as a traditional paper filing cabinet. The benefit of virtual filing is that the data in the files will constantly update as the source data in the central hub changes to provide organizational benefits that were previously impossible with a paper-based system.

A benefit of the system of the present invention is that it provides a user the framework to view, compare and contrast data from different sources in a way that mimics electronically what previously could only be performed by way of hard copy distribution. The present invention permits the automatic tracking of the activity of each user and whether the user works on a pure push, pure pull or hybrid model and the system is capable of tracking preferences and making a copy of a user's virtual filing system onto the central hub to allow a user to leave an office without bringing home a laptop. In addition, the user can log onto the central hub from home while working with the most up-to-date virtual files, with secure access and privacy for each user.

Still another object of the present invention is the ability to provide, in real time, multi-media transmissions such as audio and video transmissions as well as graphics intensive data.

With reference to the present invention the following are relevant definitions:

Site Server—The server run by the client. It includes an indexed data storage mechanism (database).

Central Server—The server with which site servers replicate with. It also has a database.

Data Element—A unit of data in the database (such as a subscription, model, country, etc.).

Data File—A large chunk of binary data (such as an image or multi-media file).

The replication service comprises the following steps:

1. The site server calls the replication servlet (central server) with a polling mechanism over short time periods.

2. The central server searches for new or updated packages for this site server.

If a package is found, then the following takes place:

The central server checks to see if the site server contains a division data of a modeling agent for each division represented by the package of portfolios from agency to client, for casting.

The same is done with each Subscription record (model portfolio and all images in a portfolio record).

The list, in the form of names of the images, is sent to the site server.

The site server downloads the images on the list and then notifies the central server with another call to the replication service; i.e., the cycle is repeated.

Step 2 is then repeated in initiating the new cycle.

The inquiry and searching step is effected in view of the fact that “push” technology is not available directly on the internet.

3. The central server searches for a new or updated Division record which the site server has access permission for.

If such a record is found, the following is effected:

The site server downloads the logo images and then notifies the central server with another call to the replication service.

Step 2 is repeated.

4. The central server searches for a new or updated Subscription record which the site server has permission for.

If such a record is found, the following takes place:

The site server downloads the subscription images and then notifies the central server with another call to the replication service.

Step 2 is repeated.

5. The server searches for a deleted Package record that belongs to the site server.

If such a record exists, then the following is effected: For each subscription in the package (note that the package will be deleted, but will still exist in the database with persistence status=‘D’), a corresponding Subscription record is sought. If it is not found then the images are added to the delete list.

The list is sent to the site server.

The site server deletes the images in the list and notifies the central server with another call to the replication service.

Step 2 is repeated.

6. The server searches for a deleted Subscription record, which the site server has permission for and for which there are no corresponding Packages.

If such a record exists, then the following is done: The list of images in the subscription is sent to the site server.

The site server deletes the images and then notifies the server.

Step 2 is repeated.

7. There are no updates, so the site server waits a specified amount of time before calling the replication service again.

Generally the present invention comprises a system for data transmission, wherein, given a site server A and a central server C, connected via a network, the replication process synchronizes (with the same data) a subset of the data elements, e.g. model characteristics, and data files, e.g., portfolios, stored at A with C.

Furthermore, data stored on C by other site servers from previous replication processes are replicated with A. The process is designed to minimize the amount of redundancy in the information sent across the network, especially downstream from the central server to the site server. Thus, if data elements residing on A are destined for C via a replication process, but those elements already exist, they will not be transferred. The situation is also true with the roles of A and C reversed. The final result of this process is that site servers can communicate potentially large quantities of data efficiently and without ever having to connect directly together. In fact, the central server need not even initiate contact with the site server. All transactions are initiated by the site servers.

Site servers indicate which data they would like other site servers to access by modifying permissions for those site servers. If a site server A gives site server B permission to a set of data and then replicates, then the next time B replicates, the result should be that B has a copy of the set of data. The central server is assumed to have permission to all the data of all the site servers.

All data images (also audio files) have unique keys associated with them. This allows for instant recognition of data. If data is deleted, the keys are not reused.

The present invention comprises a process which operates with the following steps:

1. A site server A begins the replication process. It flags all data elements and files that have been created, deleted or modified since the last replication, and sends them to the site server.

2. The central server stores the data and then examines what permissions A has to its data.

3. It sends to A all the appropriate data files that A does not already have.

4. It sends all the appropriate data elements whose status (which could be one of ‘ok’, ‘deleted’, ‘created’, or ‘modified’) has changed to either ‘deleted’, ‘created’, or ‘modified’ since the last replication performed by A.

5. For each data element e, each of the dependencies of e are sent to A if A does not already have those elements. Note that as long as A has the depending elements, the central server need not send them to A, even if those elements are out of date. Out of date elements are handled by step 4. This process of checking dependencies guarantees that the minimum amount of supporting data will go out to the site servers.

6. The site server stores the set of data received from the central server.

7. Both A and C update their status of data transmission to reflect the results of the replication process.

In a preferred embodiment of the present invention there is a separation of transferred data images and server transmission data when accessed in real time with the latter having a negligible transmission time.

The current three largest types of prior art replication while superficially similar to the present replication nevertheless embody significant differences:

1) Email Post Office Protocal (POP) is a very simple protocal that takes data and stores it for users to eventually download. New data is constantly added and the files are essentially unsorted and static. This is very different from the present system wherein there is a download, update and deletion effected via the replicator. The entire database is very dynamic and the user does not download anything to a local machine as is required with a POP. The data is instead resident on the network drive which is used by several users simultaneously.

2) Database Replication, is similar to to the present system but still has significant differences. First, under the standard replication model, the user's permissions are validated on the replicated database, which results in a serious security risk. This is avoided herein wherein the central hub server provides interactive security. Second, replicated databases rarely can support dynamic interaction with other replicated databases. The present replication system allows for smart downloads when data is needed due to messages sent between various users operating on different replicated databases. This complex intelligence separates present replication process from any current engine

3) Push technology is a very simple process. The local computer chooses which databases to download and these files are downloaded once a day (or more) to the local machine for offline use. The simplicity of the push model is why almost every push-based company has closed or changed its business plan Push has several fatal flaws that are not present in the present system replication. The first of these is static data The data is only updated daily, hourly etc. so it suffers from a lack of up-to-the-second accuracy. Secondly, push lacks interactivity from the main database or other users of the service. This lack of interactivity makes push no different from a newspaper that is printed and dropped in front of a door each morning. In fact, a newspaper is a form of push technology.

The above and additional objects, features and advantages of the present invention will be more clearly evidenced from the following discussion and drawings in which:

### SHORT DESCRIPTION OF THE DRAWINGS

FIG. 1 is a schematic overall view of the system of the present invention with linkages between modeling agency server, intermediate controlling central server and client server;

FIG. 2a is a flow chart of the operation of a first embodiment of the system of the present invention;

FIG. 2b is a flow chart of the operation of a second embodiment of the system of the present invention;

FIGS. 3a-d are representative screen shots of an on line viewing of a model's portfolio; and

FIGS. 4a-d are representative screen shots of a booking view.

### DETAILED DESCRIPTION OF THE INVENTION

The system of the present invention handles the transmission of models' portfolios and all communication among models, their agencies and their agencies'clients. The network is flexible enough to be accessed either in real-time online (using the Internet) or through a distributed database model. The system comprises a network which operates as follows:

(1) the client (e.g., an advertising agency) self-installs the “client content manager software” through a designated website;

(2) the client logs on to the system and requests from agencies permission to access the models' portfolios of the modeling agencies it wants to use;

(3) the agencies grant the client access;

(4) the client then chooses to use online access or to have the portfolios downloaded to its server/hard drive; most clients will choose the download option due to insufficient dedicated bandwidth;

(5) the model portfolios will be automatically and continuously updated to keep all information current;

(6) the client completes business as before, only more quickly and efficiently.

As modeling agencies and their clients use the network, they do not need to change any facet of how they have traditionally operated. All clients, agencies and models benefit as the models' portfolios and information are always fresh and up-to-date. The transmission of portfolios and information, which used to be done by hand and often took days or weeks, is now virtually instantaneous. The specific impact on each of these fashion market constituencies varies as described below.

The Local Content Manager (LCM) program is used to archive every photograph of every model. Scanning is done by a flatbed scanner and a typical Windows PC. These archives can then be used to create electronic model books for each board of the agency. Organizing or updating a model's book with the LCM is extremely easy and can be done in a few minutes. The LCM also allows a modeling agency to control access to the images. Each client can be granted full, limited, or denied access to model photographs and statistics.

Modeling agencies also have the ability to create custom electronic packages. These packages are the key to preserving the communication system that exists between the modeling agency and the clients. A client can call the modeling agency and outline a potential job. The booker can select the appropriate models and send an electronic package to the client in seconds which automatically uploads the appropriate data from that already stored on his server. The client can review the packages and complete the booking on the same call. This electronic system reduces the casting time from days to minutes.

There are a large number of clients with very different technological needs. Most of the large advertising agencies and magazines have newer computers, multiple users, multiple T1 lines, and very unreliable Internet connections between 8 AM and 10 PM. They are also the heaviest users of the system. These clients are given a distributed database that will be pushed to them in advance. The data will be updated every night to ensure current images of every model. The distributed architecture allows for the data to be pushed to one computer and then be shared by multiple users. This will eliminate the need to push duplicate data to every user in the company.

Although these users will be able to browse an entire modeling agency's data on occasion, they will generally rely heavily on electronic packages. Each package contains only a set of image ID numbers that relate to the models' portfolios already stored on the Client's System. This enables the package to be less than 1K in size and travel through congested bandwidth almost instantly. When it is received at the other end, it opens pictures from the existing database and displays them on screen.

The client user software system also permits a client to create an electronic filing system. These electronic files are much better than the existing paper files because they are updated automatically. They store the most current pictures of a model and even track her if she changes modeling agencies. Finally, the system allows a client to view, compare and contrast models from many different agencies simultaneously by placing them all in a file for a given job.

### Present System vs. the Web or E-mail

The following table contrasts features of the present invention against the Web or E-mail based systems.

| Feature | | Present | Web | E-mail |
|---|---|---|---|---|
| 1. | Portfolio packages immediately available | Yes | No | No |
| | (with instant notification) - No bandwidth | Yes | No | No |
| | constraints. | | | |
| 2. | Booker easily assembles and sends pack- | Yes | No | No |
| | ages to client | | | |
| 3. | Portfolios 100% current and available | Yes | No | No |
| 4. | No programming required to customize | Yes | No | No |
| | portfolios - 100% client compatible | | | |
| 5. | 100% industry standard format (no attach- | Yes | Yes | Yes |
| | ments) | | | |
| 6. | High quality images | Yes | Yes | Yes |
| 7. | Modeling agency controls access | | | |

The Imaging System used in the present invention is an object-oriented, distributed client-server database system that maintains and controls the information and its distribution to clients. Its three main modules are the Local Content Manager (LCM), the Client Content Manager (CCM) and the User software. The LCM is installed at each modeling agency to allow the agency to scan in and update new images and data changes on a daily basis. It uploads those changes to a main server on a scheduled basis. The CCM is installed at each client and is responsible for retrieving the updated information for that particular client. The User software is installed at both modeling agencies and their clients to allow individual casting agents and bookers to browse portfolios and communicate with each

Infrastructure companies that host/deliver data/images closer to clients' premises do not solve the bandwidth bottleneck situation that exists at the client's premises. Similarly, broadband Internet connections do not solve the congestion at the client's access point to the Internet.

The present system runs as a thin distributed web server with an attached database of images. The entire system is bundled into a single installation program that can detect and configure on any type of system (Mac, PC or UNIX) for either single or multi-user locations.

A web registration page on the Internet further enhances the system, by allowing any potential user to simply fill out a short form on the Internet, download an installer, and start using the system.

A SQL server conversion makes booking software much more powerful and reliable with product scalability for larger, multi-location agencies.

An Internet interface to the Booking System, comprises the following features:

1. Allow users to log on from anywhere in the world.

2. Allows models to view their schedules online.

3. Allows multi-location modeling agencies to interact with each other.

The network of the present system may be accessed either real-time online (using the Internet), or through a distributed database model for those parties who do not have true broadband access (e.g., a dedicated T-1 or DSL connection).

The network operates as follows:

(1) the client (e.g., an advertising agency) self-installs the “client content manager software” through a free website download;

(2) the client logs on to the system and requests permission from agencies to access the models' portfolios of the modeling agencies it wants to use;

(3) the agencies grant the client access;

(4) the client then chooses to use online access or to have the portfolios downloaded to its server/hard drive; most clients will choose the download option due to insufficient dedicated bandwidth;

(5) the model portfolios will be automatically and continuously updated to keep all information current;

(6) the client completes business as before, only more quickly and efficiently.

As modeling agencies and their clients use the network, they do not need to change any facet of how they have traditionally operated. All clients, agencies and models benefit as the models' portfolios and information are always up-to-date. The transmission of portfolios and information, which used to be done by hand and often took days or weeks, is now virtually instantaneous. The system components are built in Java while XML is used as an information exchange protocol. The software infrastructure has at its core high performance data and resources replication and synchronization services that permit businesses within an industry to decide when new data needs to be known to their business partners and customers. These services can run on request or can be scheduled to run as recurring tasks.

A key advantage is that the present system allows all necessary information to be positioned at the client's site before it is needed. That is, the system enables distribution, synchronization and manipulation of image and data intensive, geographically dispersed databases for business to business applications. The services are performed on request or scheduled to run at a specific time. This approach allows organizations to have all the business critical data and resources right in their backyard. This model can easily be applied to any number of industries, regardless of what type of data is being shared or the geographic location of its users.

### DETAILED DESCRIPTION OF THE DRAWINGS AND THE PREFERRED EMBODIMENTS

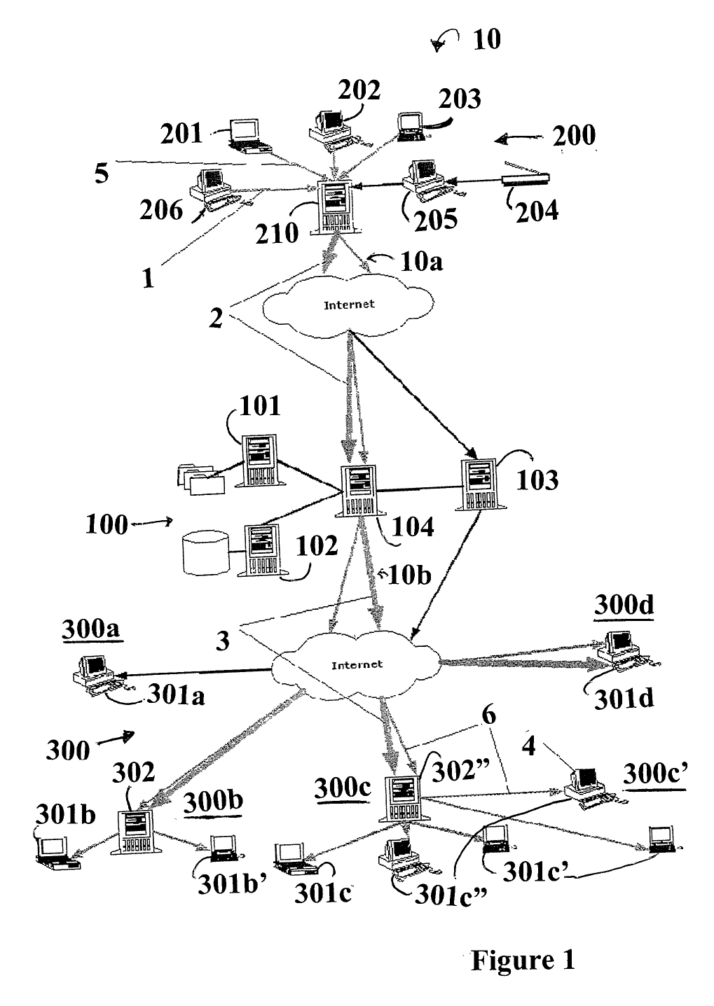

As shown in FIG. 1, the components of the system 10 of the present invention comprise three generalized operational sites connected via an internet communication network. In the embodiment shown, a central server site 100 serves to receive and distribute image and text data, as needed. The central server 100 is linked via the internet to modeling agency site 200 and client site 300. Modeling agency site 200 is shown with alternative or cumulative computers 201-203 as data package managers with Windows (Win) or Macintosh (Mac) operating systems (201 & 202, Win laptop and desktop and 203 (Mac)). Site 200 further comprises a scanner 204 for scanning images of a model book or the like with a directly linked operating computer 205 having scanning software. Local content manager computer 206 is linked to the modeling agency site server 210, as are all the computers 201-205. Digital portfolios are built at the modeling agency site 200, using the local content manager 206.

Server 210 is linked via internet connection 10a to central server site 100. The central server site comprises an image server 101 for storing and processing images, a database server 102 for storing and processing text, a web server 103 for maintaining communication with the modeling agency site 200 and client user site 300 via internet connections 10a and 10b respectively and an application 104 for coordinating stored data and images with updates from the modeling agency site 200 and a multiplicity of client sites 300a-d having varying connection criteria and requirements. Client 300a has a single terminal connection 301 a which uses a website associated with the central server site for access of data and images while clients 300b-d have dual data and image connectivity. At client 300b there is a laptop computer 301b with a user package manager with a Windows platform as a laptop computer 301b′ with a Macintosh operating system with the appropriate system user package manager, with both of the laptops being connected through client site server 302 with content manager software. Client 300c has a similar setup (with corresponding laptops 301c and 301c′ and client site server 302″) but with the addition of a desktop computer 301c″ with the user package manager software, optionally used in a LAN system shown in a second site 300c′ with additional desktop 301c″ and laptop 301c′. Client 300d is a single user client with a desktop computer 301d with content manager and package manager.

In the system 10, connection 1 permits the modeling agency to build digital portfolios using local content manager. At connection 2 (designated with thick arrows between modeling agency and central server site), the modeling agency replicates or copies portfolios to the central server 100 via an internet connection. At connection 3 (designated with thick arrows between the central server site and the client users) the client replicates portfolios from the central server and stores them onto the respective client site servers (shown as client site servers 302 and 302″). As shown at site 4 the client users can browse through portfolios, based on permissions granted by the modeling agency. At local connection 5 at modeling agency site 200, the modeling agency user or booker assembles a package of portfolios and sends to one or more contacts in the form of keys or electronic ids to unlock the portfolios at the client site 300. At connections 6 the clients instantaneously receive the package keys and are able to see the contents, i.e., the portfolios.

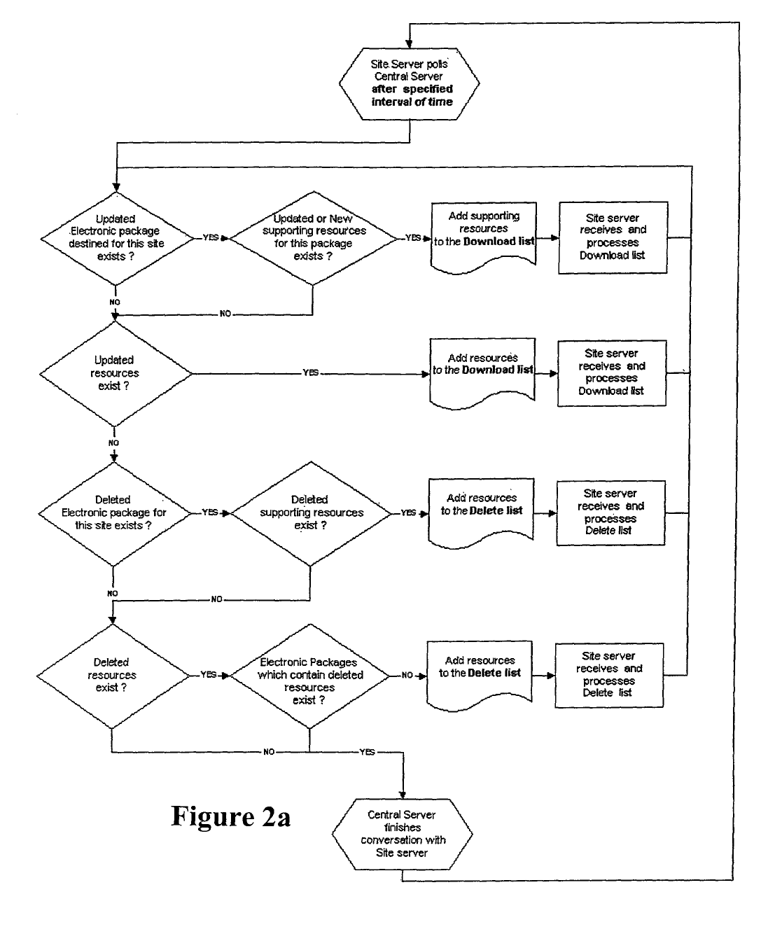

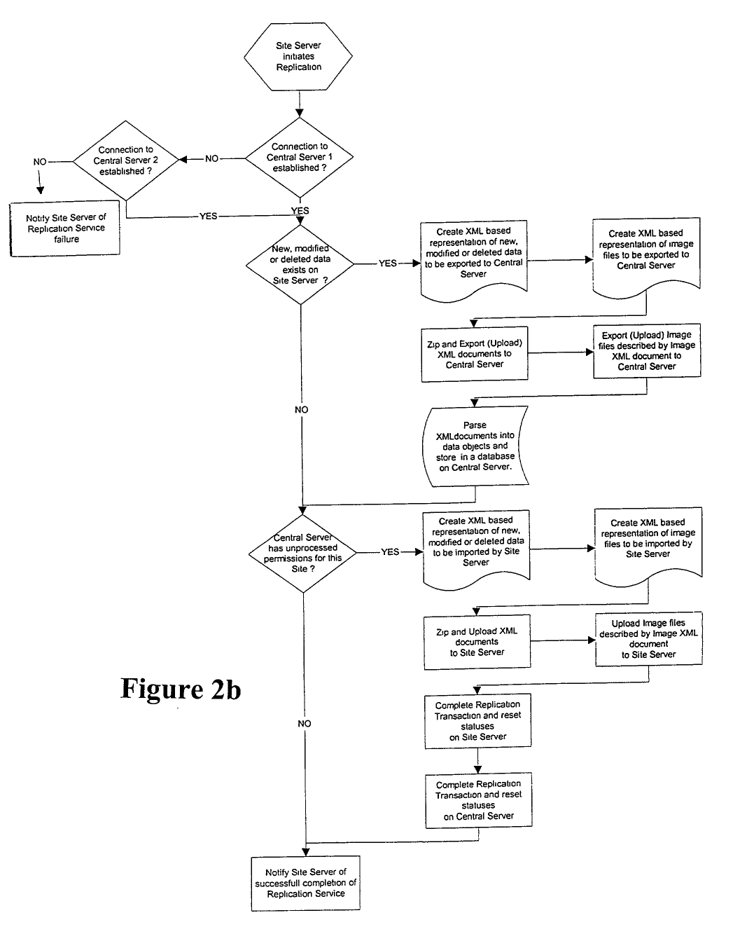

FIGS. 2a and 2b are respective logic flow charts of variations of the interaction between the central server and the client and model agency site servers with updated information relative to modified and deleted data on the site servers.

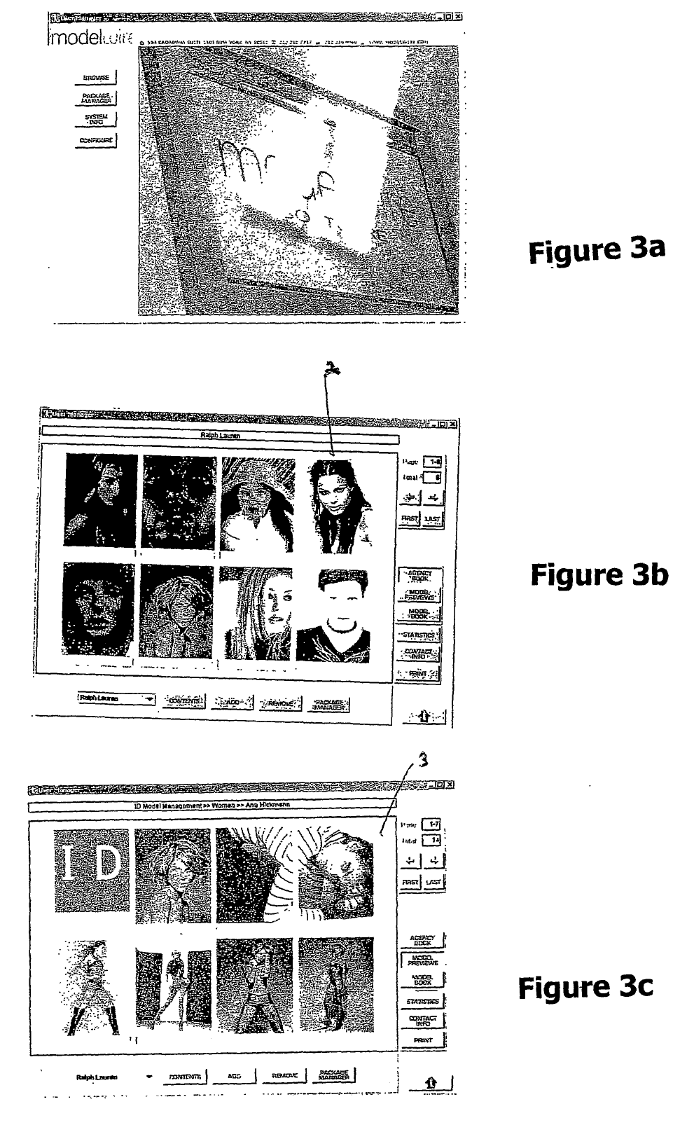

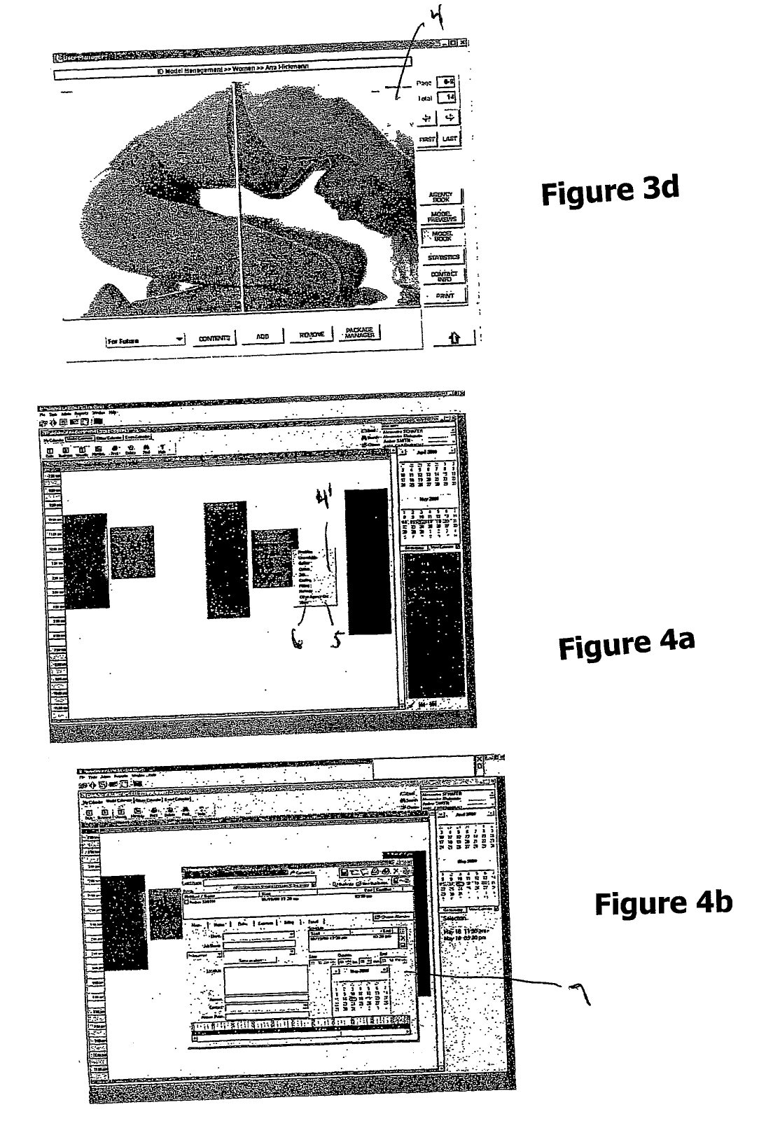

As shown in the sequence of screen shots of FIGS. 3a-d, a client of the central server calls a modeling agency and talks with a booker about what is needed for a modeling job. The booker then creates a package 1 (FIG. 3a) of models deemed appropriate for the job and the booker allows client access to the selected portfolios specific to the request. In FIG. 3b the client is able to immediately view the agency booker recommendations of models 2 for the specific project. Thereafter, as shown in FIG. 3, the client can view thumbnails 3 of a single model's book. Additionally, the client may view a single model's portfolio 4 in its actual size as shown in FIG. 3c.

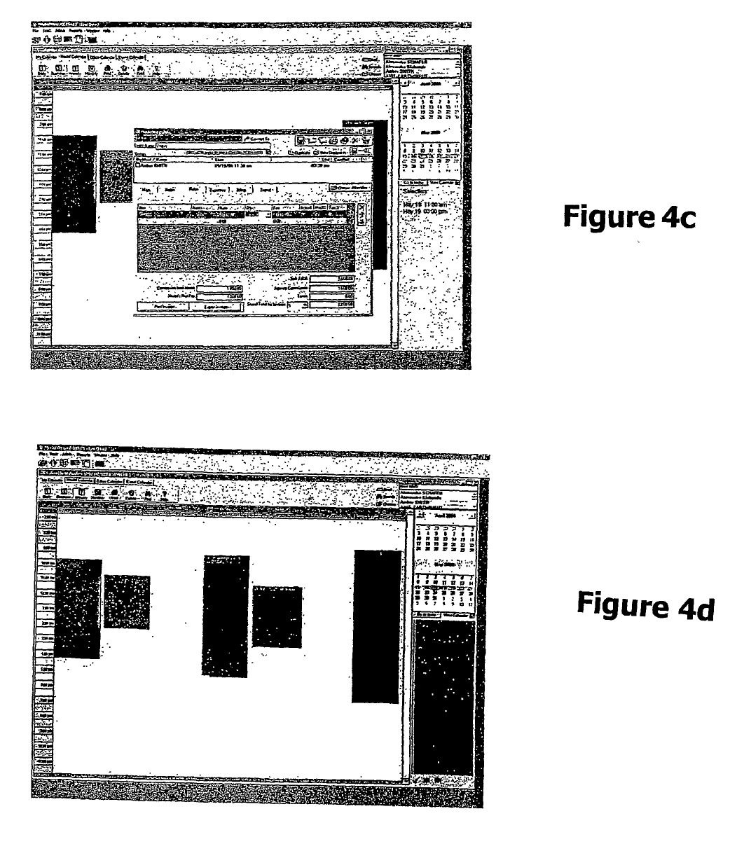

Booking or casting of a model is effected on-line as shown in FIGS. 4a-d. In order to create a casting for a model (as shown in FIG. 4a), the booker selects the time on the model calendar 4 and right clicks to bring up a drop down menu 5 shown in FIG. 4b with event choices 6. The booker selects the type of event desired with the display 7 showing the window for a confirmed job event. The booker fills in the fields which describe the clients and the time for the event. Once the information is filled out, the event is saved to the chart by a save and exit (FIG. 4c). In order to view all the event information, the booker selects the event by clicking on it (FIG. 4d). All critical details are displayed at 8 (lower right side of the screen. Simple glancing at a model's calendar makes the entire schedule available to the agency for inspection at all times.

It is understood that the above drawings and discussion of an embodiment is merely illustrative of the invention and that changes in software, configuration and system components may be made without departing from the scope of the present invention as defined in the following claims.

What is claimed is:

1. A secure system for facilitated transmission of graphic intensive data from multiple sources to a multiplicity of client users for the evaluation of said data, said system comprising a central hub comprising means for receiving graphic and text data from the sources and said central hub further comprising means for providing enhanced and facilitated access to the graphic and text data to a multiplicity of clients via continuously maintained internet connections between the central hub and the source and between the central hub and said client users, wherein said client users and said source comprise respective local data bases and said central hub comprises means for providing facilitated access of the data to the client users by providing said data as any of a push transmission, a pull transmission and a combination thereof, as appropriate for transmission of the data, whereby said client users may request all or a portion of the data from the central hub for download to a local data base of said client users and whereby said data is updated from said sources through said central hub to said client users at any desired time interval.

2. The system of claim 1, wherein said central hub comprises a central data base, and wherein said system comprises means to permit any of said client users to access said central database directly through the internet to provide live interactivity with other of said client users.

3. The system of claim 1, wherein said combination of push and pull transmissions is adapted to enable the client users to interact with electronic packages comprising a reference to a subset of graphic images and text data, pre-selected by one of said client users and transmitted to another of said client users, wherein the electronic packages refer to data previously pushed toward all of said client users.

4. The system of claim 3, wherein the electronic packages comprise intelligent detection means to detect if data on a local data base is complete or inaccurate and if said data is incomplete or inaccurate, comprises means for automatically retrieving data to complete or correct the incomplete or inaccurate data respectively, from the central hub.

5. The system of claim 4, wherein said electronic packages comprise means for organizing data into personal files for each of said client users whereby said client users can structure a virtual filing system with data capable of being constantly updated by the central hub as the data from the sources is changed.

6. A method of replication of data for client user sites using the system of claim 1, and wherein the sources comprise modeling agents, said method comprising the steps of:
a) a client user site server calling the central server of the central hub with a polling mechanism over short time periods asking for the receipt of modeling agent data in an electronic package;
b) the central server searching for new or updated packages from the modeling agents for the requesting client user site server;
c) if a package is found, then:
1. the central server checks to see if the client user site server contains a division data of a modeling agent for each division represented by the package of portfolios from agency to client, for casting, with the same being done with each subscription record of model portfolio and all images in a portfolio record;
2. a list, in the form of names of the image or multi-media data, is sent to the site server;
the site server downloads the images or multi-media data on the list and then notifies the central server with another call for replication wherein the cycle is repeated;
step 2 is then repeated in initiating the new cycle;
3. the central server searches for a new or updated division record which the site server has access permission for; and if such a record is found, then:
the site server downloads logo images and then notifies the central server with another call for replication;
step 2 is repeated;
4. the central server searches for a new or updated Subscription record which the site server has permission for and if such a record is found, then:
the site server downloads the subscription images and then notifies the central server with another call for replication;
step 2 is repeated.
5. the server searches for a deleted Package record that belongs to the site server and if such a record exists, then:
for each subscription in the package; wherein though a package is deleted, it will still exist in the database with a persistence status; a corresponding Subscription record is sought; and if it is not found by then the images are added to the delete list;
the list is sent to the site server.
the site server deletes the images in the list and notifies the central server with another call for replication;
step 2 is repeated;
6. the server searches for a deleted Subscription record, which the site server has permission for and for which there are no corresponding Packages and If such a record exists, then:
the list of images in the subscription is sent to the site server;
the site server deletes the images and then notifies the server;
step 2 is repeated; and if there are no updates, the site server waits a specified amount of time before calling for replication service again.

7. A system for data transmission, comprising a site server and a central server, connected via a network, wherein a replication process synchronizes, with the same data, a subset of the data elements, stored at the site server and with the central server; and wherein data stored on the central server by other site servers are replicated with the site server to minimize the amount of redundancy in the information sent across the network, wherein, if data elements residing on the site server are destined for the central server via a replication process, but those elements already exist, they will not be transferred and if data elements residing on the central server destined for the site server already exist, they will not be transferred whereby site servers are able to efficiently communicate potentially large quantities of data without ever having to connect directly with each other and wherein all data transactions are initiated by the site servers; wherein site servers indicate which data they would like other site servers to access by modifying permissions for those site servers; and wherein if a first site server gives a second site server permission to a set of data and then replicates, then the next time the second site server replicates, the second site server obtains a copy of the set of data; wherein the central server has permission to all the data of all the site servers.

8. The system of claim 7 wherein all data images and multi-media files have unique keys associated with them to provide instant recognition of data; and wherein if data is deleted, the keys are not reused.

9. A process for the replication of data comprising the steps:
(1) a site server begins a replication process whereby it flags all data elements and files that have been created, deleted or modified since a prior replication, and sends them to the site server;
(2) a central server stores the data and then examines what permissions the site server has to its data
(3) the central server sends to the site server all the appropriate data files that the site server does not already have;
(4) the central server sends all the appropriate data elements whose status selected from one of ‘ok’, ‘deleted’, ‘created’, or ‘modified’ has changed to either ‘deleted’, ‘created’, or ‘modified’ since the last replication performed by the site server;
(5) for each data element, each of the dependencies of the data element are sent to the site server if the site server does not already have those elements; wherein as long as the site server has the depending elements, the central server need not send them to the site server, even if those elements are out of date; wherein out of date elements are handled by step 4, whereby checking dependencies guarantees that the minimum amount of supporting data will go out to the site servers;
(6) the site server stores the set of data received from the central server; and
(7) both site server and central server update their status of data transmission to reflect the results of the replication process.
